(19) United States
(12) Patent Application Publication
(10) Pub. No.: US 2024/0301645 A1
(43) Pub. Date: Sep. 12, 2024

(54) METHODS AND PREPARATION FOR MAN HOLE HANGER

(71) Applicant: ABC Services & Consulting LLC, Phoenix, AZ (US)

(72) Inventor: William Geer, Avondale, AZ (US)

(73) Assignee: ABC Services & Consulting LLC, Phoenix, AZ (US)

(21) Appl. No.: 18/178,637

(22) Filed: Mar. 6, 2023

(51) Int. Cl. E02D 29/12; F16M 13/02

(52) U.S. Cl. CPC E02D 29/12; F16M 13/022

(57) ABSTRACT

A water sample hanger according to various aspects of the present technology comprises a hanger device having at least one extendable arm. In a representative example, the hanger device comprises a pair of extendable arms configured to sit on a lip of the manhole to allow a central body section to be positioned below the manhole cover. A piece of test equipment may be suspended from the central body section by one or more connectors. Each arm may comprise a foot having a flat upper and lower surface that configured to be positioned on the lip and allow the manhole cover to sit flat on the lip so that it doesn't protrude above a surface level of the manhole.

### BACKGROUND OF THE TECHNOLOGY

Underground utilities are commonly accessed through manholes places at surface or street level. A manhole cover is used to close off the opening to the manhole when services are not being performed within the manhole. It is sometimes necessary to temporarily install testing equipment with a manhole. For example, it is often necessary to obtain water samples from an underground sewer line. In these instances, a water sampler may be lowered into the manhole such that it can take sample readings. This testing may have to take place over several hours or days and the test equipment may be adapted to take periodic samples automatically. Therefore, the test equipment can be lowered into position and the manhole cover replaced so that a roadway isn't required to be closed off for an extended period of time.

Various types of devices exist to allow test equipment to be positioned within a manhole. A common problem, however, is that these devices are limited in use by the diameter of a given manhole. This requires personnel to carry various sizes of devices. The size and weight of these devices may also make use by a single person difficult.

### SUMMARY OF THE TECHNOLOGY

A water sample hanger according to various aspects of the present technology comprises a hanger device having at least one extendable arm. In a representative example, the hanger device comprises a pair of extendable arms configured to sit on a lip of the manhole to allow a central body section to be positioned below the manhole cover. A piece of test equipment may be suspended from the central body section by one or more connectors. Each arm may comprise a foot having a flat upper and lower surface that configured to be positioned on the lip and allow the manhole cover to sit flat on the lip so that it doesn't protrude above a surface level of the manhole.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 representatively illustrates a hanger device holding a testing device positioned within a manhole in accordance with an exemplary embodiment of the present technology;

FIG. 2 representatively illustrates the hanger device shown in FIG. 1 without the testing device in accordance with an exemplary embodiment of the present technology;

FIG. 3 representatively illustrates a side view of the hanger device in accordance with an exemplary embodiment of the present technology;

FIG. 4 representatively illustrates a cross-sectional side view of the hanger device with a set of extendable arms in the fully retracted position in accordance with an exemplary embodiment of the present technology;

FIG. 5 representatively illustrates a cross-sectional side view of the hanger device with the set of extendable arms in the fully extended position in accordance with an exemplary embodiment of the present technology;

FIG. 6 representatively illustrates a perspective view of the hanger device with the set of extendable arms in the fully retracted position in accordance with an exemplary embodiment of the present technology; and

FIG. 7 representatively illustrates a perspective view of the hanger device with the set of extendable arms in the fully extended position in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may be used with any number of underground utility access points. Methods and preparation for a water sampler hanger according to various aspects of the present technology may operate in conjunction with any type of test equipment suspended from a ground level manhole into a below ground utility. The present technology describes a device that holds a piece of test equipment in place irrespective of a diameter of the manhole while allowing a manhole cover to remain flush with or sit just below ground level.

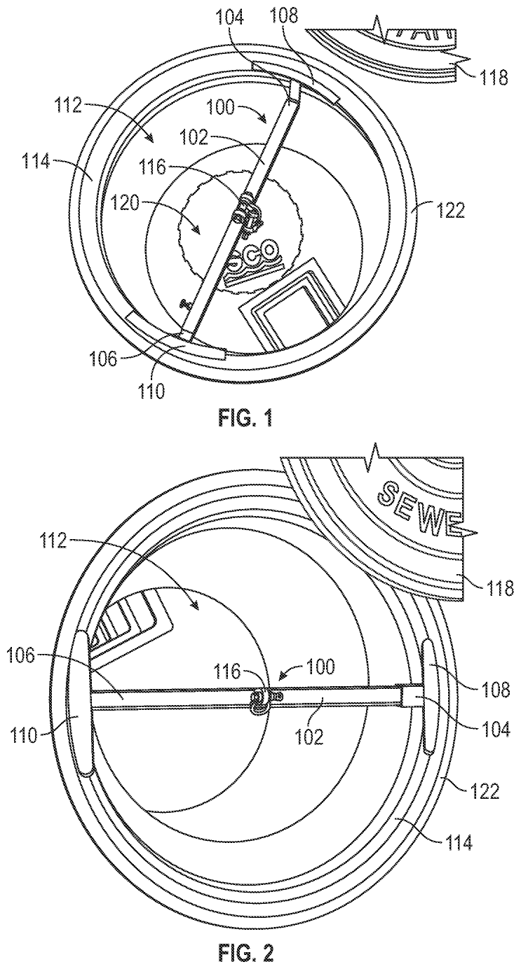

Referring now to FIGS. 1 and 2, a manhole cover 118 is sized to be seated on a lip 114 of a manhole 112 to cover the manhole 112 and prevent anything from inadvertently falling into the manhole 112. A water sampler hanger 100 is configured to be positioned on the lip 114 of the manhole 112 to allow a piece of test equipment 120, such as a waste water sampler, to be lowered into the manhole 112. The test equipment 120 may be suspended from a connector 116 on the water sampler hanger 100 and held in place during use. The water sampler hanger 100 is configured to be positioned below the lip 114 such that the manhole cover 118 can be fully seated on the lip 114 and not extend above an outer ring 122 of the manhole 112.

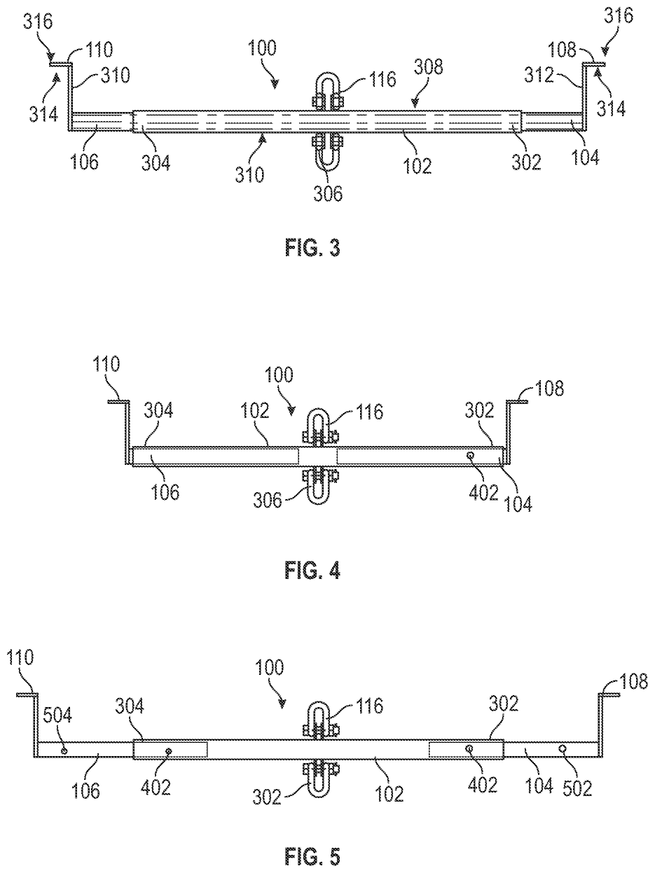

With reference now to FIG. 3, the water sampler hanger 100 may comprise a central body section 102 and a pair of opposing arms 104, 106 extending outwardly from opposite first and second ends 302, 304 of the central body section 102. The central body section 102 may comprise any suitable size or shape capable of supporting the weight of the test equipment 120 while also fitting within a diameter of the manhole 112 opening and being resistant to environmental conditions such as water, ice, and temperature extremes. For example, in one embodiment, the central body section may comprise a metal tube having a length of between about 12 inches (30.5 cm) and about 30 inches (76.2 cm) that is capable of supporting a weight of up to about 70 pounds (31.8 kg). In alternative embodiments, the central body section 102 may be formed from composite materials that do not degrade when exposed to the environment.

The central body section 102 may also comprise one or more connectors 116, 306 suitably configured to be connected to the test equipment 120 and secure it in place during use. The connectors 116, 306 may comprise any suitable system or device for securely holding another object such as a clip, shackle, carabiner, hook, eye bolt, or the like. For example, a first connector 116 may comprise a clevis disposed along an upper facing surface 308 of the central body section 102. Similarly, a second connector 306 may be disposed along a lower facing surface 310 of the central body section 102 either in addition to or in place of the first connector 116.

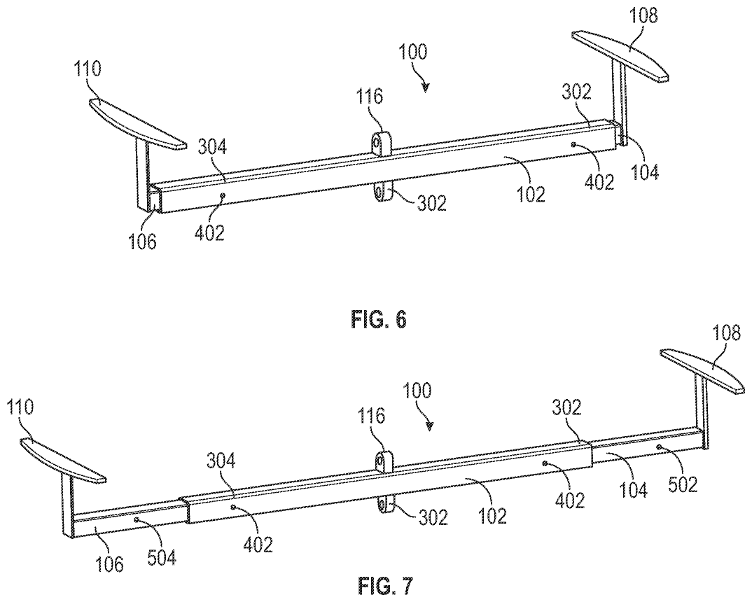

The opposing arms 104, 106 are configured to allow the water sampler hanger 100 to be positioned within varying sizes of manholes 112. The arms 104, 106 may comprise any suitable device for allowing the central body section 102 to be positioned within the center of any commonly sized manhole 112. For example, in one embodiment, and referring now to FIGS. 4-7, the arms 104, 106 may be sized to be slidably inserted into the central body section 102 such that each arm may be independently extended from the central body section to a desired length. If each arm 104, 106 is in a fully inserted position, the water sampler hanger 100 may have a total length that is only slightly longer than the length of the central body section 102 and be configured to be positioned within a manhole 112 with a relatively narrow diameter (see FIG. 4). Alternatively, if each arm 104, 106 is in a fully extended position, the water sampler hanger 100 may have a length of approximately double the length of the central body section 102 allowing the water sampler hanger 100 to be positioned within a larger manhole (FIG. 5).

In an alternative embodiment, the opposing arms 104, 106 may each comprise a tubular structure and be configured to slide over the first and second ends 302, 304 of the central body section 102.

The central body section 102 and the opposing arms 104, 106 may further configured to allow the arms 104,106 to be locked or otherwise fixed at a given amount of extension from the first and second ends 302, 304. The mechanism used to allow each arm 104, 106 to be fixed in place may comprise any suitable locking mechanism or device.

For example, in one embodiment, each of the opposing arms 104, 106 may comprise one or more through holes 502, 504 disposed along a surface of each respective arm 104, 106. The central body section 102 may comprise a set of through holes 402, wherein one hole of the set is positioned proximate the first and second ends 302, 304. The set of through holes 402 may be configured to align with the one or more through holes 502, 504 on the arms 104, 106 such that a removable locking pin (not shown) can be inserted into the aligned holes on each arm 104, 106 to lock the respective arm 104, 106 at a set distance of extension. One of skill in the art will recognize that including multiple through holes along each arm 104, 106 will allow the arm to be fixed in position at varying lengths thereby allowing the water sampler hanger 100 to be used with manholes 112 having lips 114 of varying sizes of diameters.

In an alternative embodiment, each opposing arm may comprise one or more spring buttons (not shown) disposed along the length of the arm 104, 106 configured to engage the set of holes 402 on the central body section 102 and fix the arms 104, 106 in position during use. For example, a first set of spring buttons may be positioned on the arms 104, 106 to engage the set of holes 402 on the central body section 102 when the arms 104, 106 are in the fully retracted position. A second set of spring buttons may be positioned on the arms 104, 106 to engage the set of holes 402 on the central body section 102 when the arms 104, 106 are in the fully extended position. Additional spring buttons may be positioned along the arms to allow the arms to be fixed in positioned at some position between fully extended and fully retracted. Alternatively, the central body section 102 may comprise a set of holes disposed between the first and second ends 302, 304 and a mid-portion such that a single spring button on the arms 104, 106 can be used to adjust the extended position of the arms.

Referring now to FIG. 3, each of the opposing arms 104, 106 may comprise a foot 108, 110 extending above the arm 104, 106 by a leg element 310, 312. Each leg element 310, 312 may be oriented about 90-degrees relative to the length of the arms 104, 106. Similarly, the foot 108, 110 of each arm 104, 106 may be oriented about 90-degrees relative to the corresponding leg element 310, 312. A lower surface 314 of each foot 310, 312 is configured to be positioned on the lip 114 of the manhole 112 during use to hold the water sampler hanger 100 in place. In addition, and referring now to FIGS. 1, 2, 6, and 7, an outer edge 316 of each foot 108, 110 may be curved to at least partially conform to a radius of the lip 114. The curved edge may allow the arms 104, 106 to be positioned more securely against a vertical wall of the lip 114 and allow for a tighter fit to thereby reduce the amount of play between the water sampler hanger 100 and the walls of the manhole 112 and lip 114.

A height of the leg elements 310, 312 may determine how far below the lip 114 the central body section 102 is positioned during use. For example, each leg element 310, 312 may comprise a height of between about 2 inches (5 cm) and about 7 inches (17.8 cm). The height of the leg elements 310, 312 may be determined according to any suitable criterial such as a size of the connector 116 positioned on the upper surface 308 of the central body section 102.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the technology has been described with reference to specific exemplary embodiments. Various modifications and changes may be made, however, without departing from the scope of the present technology as set forth in the claims. The specification and figures are illustrative, rather than restrictive, and modifications are intended to be included within the scope of the present technology. Accordingly, the scope of the technology should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims. Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise,” “comprises,” “comprising,” “having,” “including,” “includes,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

1. A hanger device for deploying testing equipment into a man hole having a lip for receiving a manhole cover, comprising:
a central body section having opposing first and second ends;
a pair of opposing arms configured to be selectively extended outwardly from the first and second ends of the central body section, wherein each of the opposing arms comprises;
a leg oriented approximately 90 degrees to length of the arm and extending above an upper surface of the central body section; and
a foot oriented approximately 90 degrees to the leg and extending away from the central body section to allow:
the foot to be positioned on the lip of the manhole; and
the central body section to be positioned within the manhole below the lip; and
a connector disposed on the central body section.

2. A hanger device according to claim 1, wherein the connector is disposed along a lower facing surface of the central body section.

3. A hanger device according to claim 1, further comprising a second connector wherein:
the first connector is disposed along a lower facing surface of the central body section; and
the second connector is disposed along the upper surface of the central body section.

4. A hanger device according to claim 1, wherein:
the central body section comprises a hollow tube; and
each of the opposing arms comprises a member configured to be slidably inserted into one of the first and second ends of the central body section.

5. A hanger device according to claim 4, wherein the central body section is further configured to engage each of the opposing arms to hold each in place relative to the central body section.

6. A hanger device according to claim 5, further comprising:
a first through hole located between the connector and the first end of the central body section, wherein the first through hole extends between a first side and a second side of the central body section;
a second through hole located between the connector and the second end of the central body section, wherein the first through hole extends between the first side and the second side of the central body section;
a set of at least two through holes on each of the opposing arms extending between a first side and a second side of the respective arm;
a first locking pin configured to be inserted into a first mating set of holes between one of the opposing arms and the first through hole; and
a second locking pin configured to be inserted into a second mating set of holes between the second opposing arm and the second through hole.

7. A hanger device according to claim 5, further comprising:
a first set of at least two through holes located between the connector and the first end of the central body section, wherein the first through hole extends between a first side and a second side of the central body section;
a second set of at least two through holes located between the connector and the second end of the central body section, wherein the first through hole extends between the first side and the second side of the central body section; and
a spring button on each of the opposing arms positioned between a first end and the leg of the respective arm, wherein the spring button is configured to engage one of the through holes to lock the respective arm in position.

8. A hanger device according to claim 1, wherein each foot comprises a rounded edge configured to substantially conform to a radius of the lip of the manhole.

9. A hanger device for deploying testing equipment into a man hole having a lip for receiving a manhole cover, comprising:
a central body section, comprising:
opposing first and second ends; and
a connector disposed on the central body section;
a first arm located at the first end;
a second arm located at the second end, wherein:
at least one of the arms is configured to be outwardly extendable from its respective end of the central body section; and
each of the opposing arms comprises;
a leg oriented approximately 90 degrees to length of the arm and extending above an upper surface of the central body section; and
a foot oriented approximately 90 degrees to the leg and extending away from the central body section to allow:
the foot to be positioned on the lip of the manhole; and
the central body section to be positioned within the manhole below the lip.

10. A hanger device according to claim 9, wherein the connector is disposed along a lower facing surface of the central body section.

11. A hanger device according to claim 9, further comprising a second connector wherein:
the first connector is disposed along a lower facing surface of the central body section; and
the second connector is disposed along the upper surface of the central body section.

12. A hanger device according to claim 9, wherein:
the central body section comprises a hollow tube; and
each of the arms comprises a member configured to be slidably inserted into one of the first and second ends of the central body section.

13. A hanger device according to claim 12, wherein the central body section is further configured to engage each of the opposing arms to hold each in place relative to the central body section.

14. A hanger device according to claim 13, further comprising:
a first through hole located between the connector and the first end of the central body section, wherein the first through hole extends between a first side and a second side of the central body section;
a second through hole located between the connector and the second end of the central body section, wherein the first through hole extends between the first side and the second side of the central body section;
a set of at least two through holes on each of the opposing arms extending between a first side and a second side of the respective arm;
a first locking pin configured to be inserted into a first mating set of holes between one of the opposing arms and the first through hole; and
a second locking pin configured to be inserted into a second mating set of holes between the second opposing arm and the second through hole.

15. A hanger device according to claim 13, further comprising:
a first set of at least two through holes located between the connector and the first end of the central body section, wherein the first through hole extends between a first side and a second side of the central body section;
a second set of at least two through holes located between the connector and the second end of the central body section, wherein the first through hole extends between the first side and the second side of the central body section; and
a spring button on each of the opposing arms positioned between a first end and the leg of the respective arm, wherein the spring button is configured to engage one of the through holes to lock the respective arm in position.

16. A hanger device according to claim 9, wherein each foot comprises a rounded edge configured to substantially conform to a radius of the lip of the manhole.
